(19) United States
(12) Patent Application Publication
(10) Pub. No.: US 2011/0285745 A1
(43) Pub. Date: Nov. 24, 2011

(54) METHOD AND APPARATUS FOR TOUCH SCREEN ASSISTED WHITE BALANCE

(75) Inventors: Buyue Zhang, Plano, TX (US); Mark N. Gamadia, Longmont, CO (US)

(73) Assignee: TEXAS INSTRUMENTS INCORPORATED, Dallas, TX (US)

(21) Appl. No.: 13/099,560

(22) Filed: May 3, 2011

Related U.S. Application Data
(60) Provisional application No. 61/345,716, filed on May 18, 2010.

(51) Int. Cl. H04N 9/73

(52) U.S. Cl. 345/593

(57) ABSTRACT

A method and apparatus for performing automatic white balance utilizing a touch screen. The method includes determining an area on a touch screen for performing automatic white balance, extracting portion of a frame relating to the determined area, determining red, green and blue values of the extracted portion of the frame, and performing automatic white balance based on the determined red, green and blue values.

### CROSS-REFERENCE TO RELATED APPLICATIONS

This application claims benefit of U.S. provisional patent application Ser. No. 61/345,716, filed May 18, 2010, which is herein incorporated by reference.

### BACKGROUND OF THE INVENTION

1. Field of the Invention

Embodiments of the present invention generally relate to a method and apparatus for touch screen assisted white balance.

2. Description of the Related Art

All of these challenges decrease the accuracy of an automatic white balance algorithm and often leads to an incorrect, and often undesirable, color cast or color cast residue in the image. Because of these limitations of a pure automatic white balance method, manual white balance is still widely used by professional photographers. In manual white balance, the user can select from a list of pre-defined illumination settings in the camera, such as daylight, fluorescent, incandescent, etc. The camera then performs the white balance correction based on the pre-set illumination. However, these pre-set illuminant conditions may not accurately represent the real illuminant of the scene. Hence, the white balance result may not be optimal since there may be some residual color cast left on the image. In other cases, the photographer captures a gray chart with his/her camera, and performs off-line white balance using imaging editing software. Such off-line procedures are not convenient for normal consumers since they require expert knowledge to perform.

Touch screen have become prevalent in consumer smart phones and various display devices. Several name brand digital cameras have also added touch screen camera controls to their preview displays. This provides a unique opportunity for a new kind of white balance technology.

Therefore, there is a need for an improved assisted white balance for displays.

### SUMMARY

Embodiments of the present invention relate to a method and apparatus for performing automatic white balance utilizing a touch screen. The method includes determining an area on a touch screen for performing automatic white balance, extracting portion of a frame relating to the determined area, determining red, green and blue values of the extracted portion of the frame, and performing automatic white balance based on the determined red, green and blue values.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a flow diagram for a method of the touch screen assisted white balance method;

FIG. 2 is an embodiment of the touch screen based white balance technology: (a) a scene with automatic white balance; (b) selecting a neutral region in the scene; (c) region 1 is located on a pink surface while and region 2 is located on a blue surface; (d) the result of performing white balance based on region 1; and (e) the result of performing white balance based on region 2;

FIG. 3 is an embodiment of an automatic white balance (AWB) zones on preview frame;

FIG. 4 is an embodiment of another flow diagram for utilizing a touch screen of a display; and

FIG. 5 is an embodiment of an apparatus for performing automatic white balance utilizing a touch screen of a display.

### DETAILED DESCRIPTION

White balance is utilized to make white appear “white”. A digital color image consists of three components at each pixel, which are red, green, and blue. A neutral color refers to color with equal amount of red, green, and blue. In an automatic white balance method, the “white” or neutral region in an image is estimated and thereafter, the red, green, and blue components of the estimated neutral region are equalized. By doing so, the color cast of the neutral region is removed, and the rest of the colors in the image are also brought into proper balance. Assuming the summation of the red, green, and blue components of the estimated neutral region are sumR, sumG, and sumB, respectively, the white balance gains can be computed by (1)-(3):

R_gain=sumG/sumR (1)

B_gain=sumG/sumB (2)

G_gain=1 (3)

The gains are then applied to the entire image, denoted as img, for white balance correction:

img_corrected(:,:,1)=img(:,:,1)*R_gain (4)

img_corrected(:,:,2)=img(:,:,2)*G_gain (5)

img_corrected(:,:,3)=img(:,:,3)*B_gain (6)

Color temperature of the scene may be estimated by comparing the chromaticity of the selected neutral region with that of the color temperature references stored in the camera. For example, if the camera has stored the chromaticity of 18% gray, under 6500K, 5000K, 4000K, and 3000K illuminations, the estimated color temperature will come from the reference with the chromaticity closest to that of the selected neutral region.

The main challenge that an automatic white balance method faces is that the surface color of an object under one illumination is often indistinguishable from another surface color under a different illumination. For example, the chromaticity of certain yellow color under daylight is almost identical to that of a neutral gray color under an incandescent light source. Moreover, the presence of a large amount of one object color tends to bias the estimation of the true neutral region towards that one color.

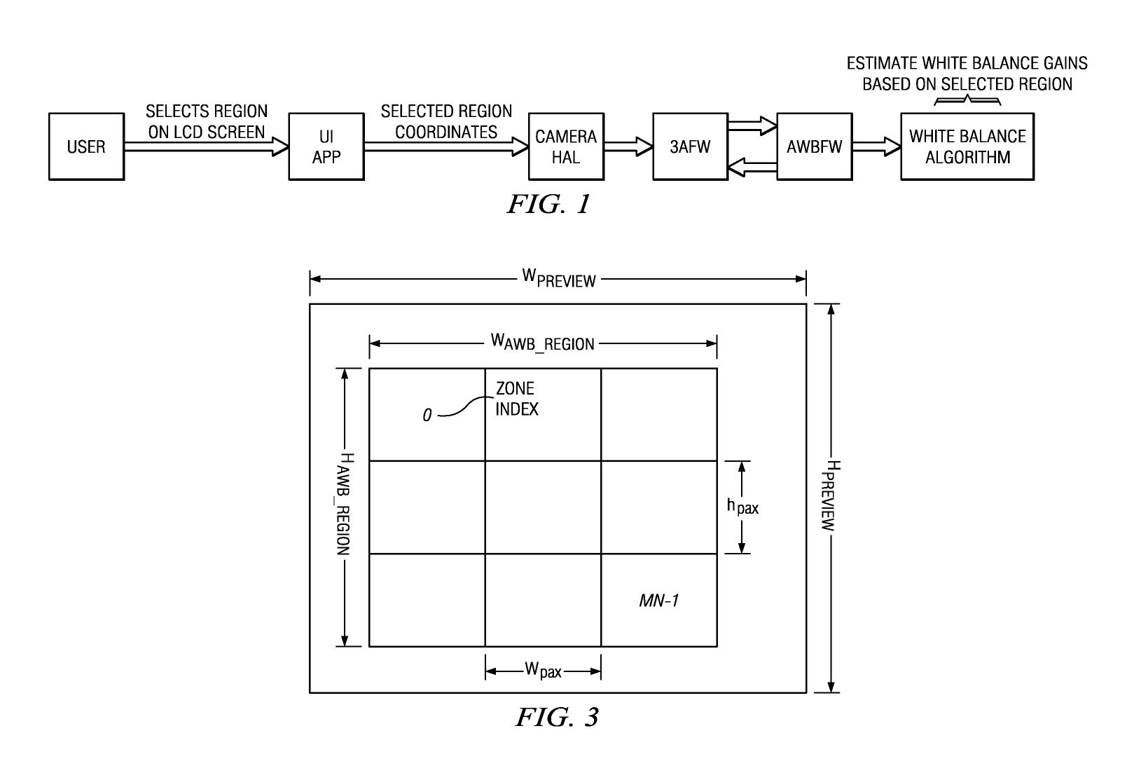

The touch-screen based white balance method proposed in this invention overcomes the challenges of the automatic white balance method and provides an intuitive means of achieving manual white balance without requiring the consumer to have expert knowledge. It also provides great flexibility as well as convenience for user to achieve a desired white balance result. It can be used to complement automatic white balance, as well as, the manual white balance in a display. The flow diagram of the touch screen based white balance method is shown in FIG. 1. FIG. 1 is an embodiment of a flow diagram for a method 100 of the touch screen assisted white balance method

In one embodiment, the user selects the desired neutral region, and white balance gains are directly computed from the selected region as shown in eqn (1)-(3). In another embodiment, an algorithm performs automatic white balance in a selected region. In this case, the system may run an automatic white balance algorithm, but it searches for the best color temperature and white balance gains in a reduced region of the image, which has been selected by the user.

The touch screened based white balance may start with a user points the camera at a desired scene for shooting. She or he can then indicate a region as neutral region by tapping the upper left and lower right corner of that region. Note that the selected region does not have to be rectangular; it can be circular, as well. In such a case, the user may tap one point as the center of the circle followed by another point to indicate the radius of the circle. Since human eyes have the unique mechanism of color constancy, the true object color will be seen regardless of the illumination. It is easy for a human observer to pick up the correct neutral region. Secondly, white balance correction is performed, for example. white balance gain estimation and color temperature estimation, which maybe based on the selected neutral region, as shown in equations (1)-(6).

In another scenario, there is no neutral color in the selected scene A, such as the close up of a red flower. In this case, the user could first point the camera to a scene B with neutral colors, such as pavement, a concrete wall, or even a gray chart if it is available. Since neutral color is the most common color in nature, it will not be difficult to locate it. The user then touch selects the neutral region in scene B, and then white balance is performed via equations (1)-(6). The white balance gains and color temperature estimation based on the neutral color in scene B will then be applied to scene A, when A is captured or displayed. The computed white balance gain information may also be stored for application to subsequent images until the next time the user resets the white balance via touch selected neutral region.

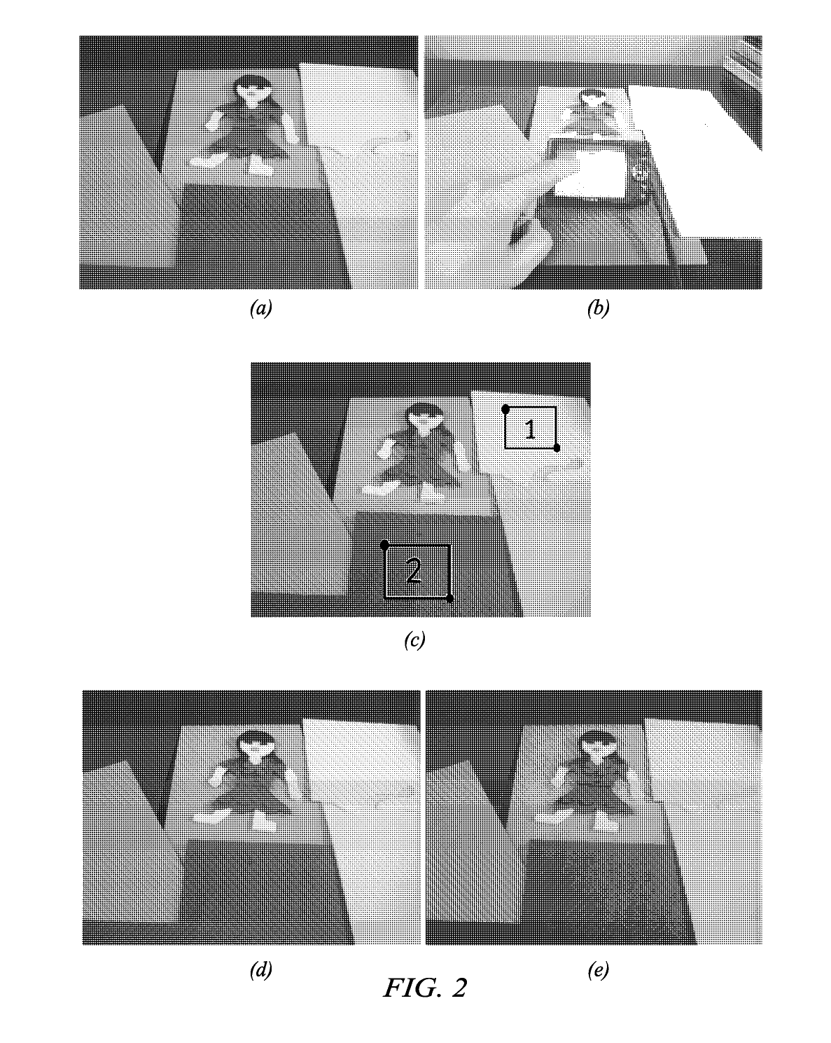

FIG. 2 depicts an embodiment of the touch screen based white balance technology: (a) a scene with automatic white balance; (b) selecting a neutral region in the scene; (c) region 1 is located on a pink surface while and region 2 is located on a blue surface; (d) the result of performing white balance based on region 1; and (e) the result of performing white balance based on region 2.

In the case the user wants to achieve a special tone effect for his/her photos, touch screen based white balance can enable such a function or capability. For a cooler tone, the user may select, for example, a reddish/yellowish region in the image, such as region 1 in FIG. 2(c). FIG. 2(d) shows the white balance result of using region 1 as neutral region. Neutralizing a reddish/yellowish region will introduce a bluish cast to the image, thus producing a cooler tone. Similarly, to achieve a warmer tone, the user may select a bluish region as the neutral region, such as region 2 in FIG. 2(c). FIG. 2(e) shows the result of using region 2 for white balance. Such creative white balance effects are enabled by this invention.

In another embodiment, the touch screen based white balance may start with previewing a frame on a display that is divided into K zones. Assume horizontally there are M regions, and vertically N regions, then K=M*N, as shown in FIG. 3. FIG. 3 is an embodiment of an automatic white balance (AWB) zones on preview frame. One example implementation is M=15 and N=15. Then, when the user taps on the display, the position the user has tapped is mapped to an automatic white balance zone on the previewed frame. That zone becomes a valid automatic white balance zone. If the position locates on the grid of two or more adjacent zones, all of the zones become valid automatic white balance zones.

Afterwards, an automatic white balance algorithm is then performed on the selected valid automatic white balance zones, to estimate color temperature and white balance correction gains. The automatic white balance algorithm could be any auto white balance algorithm. By reducing the search space, the result of an automatic white balance algorithm enjoys improved accuracy and robustness. Finally, if there is no good region for doing white balance in the desired scene A, such as, a close up of a flower, the user could first point the camera to a scene B with neutral color to calibrate the white balance settings with scene B. Then, capture other scenes with this white balance setting until there is a change of illumination.

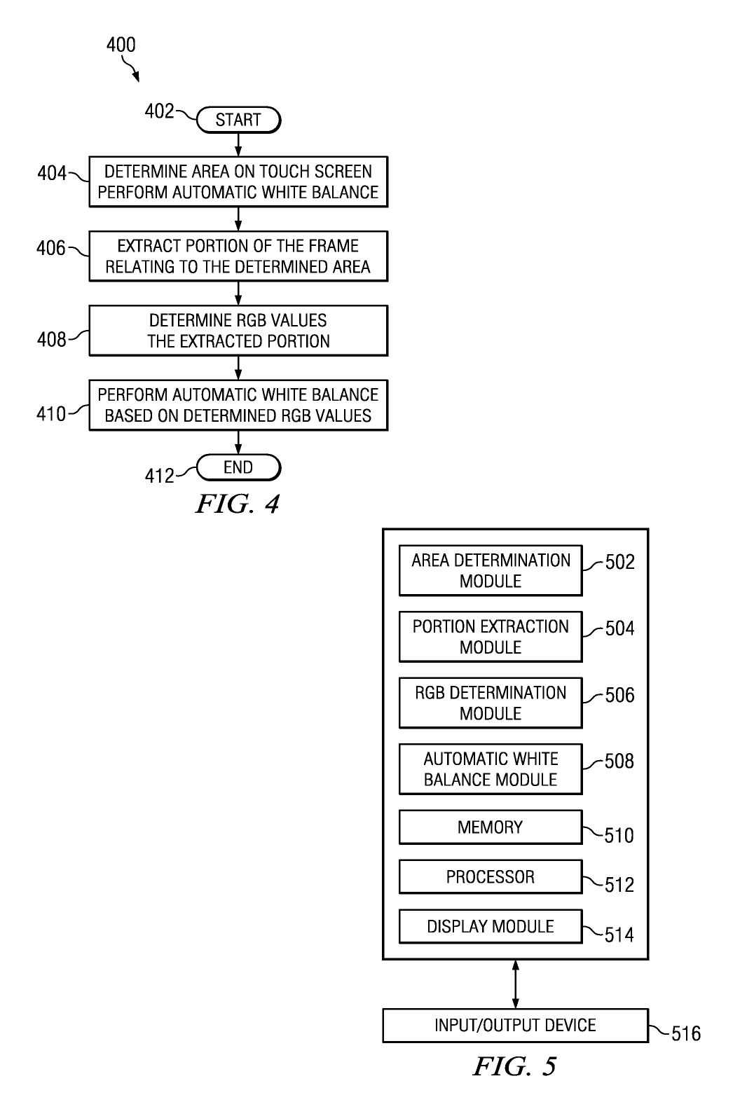

FIG. 4 is an embodiment of another flow diagram for a method 400 of performing automatic white balance utilizing a touch screen of a display. The method 400 starts at step 402 and proceeds to step 404. At step 404, the method 400 determines an area on a touch screen display for performing automatic white balance. At step 406, the method 400 extracts portions of the frame relating to the determined area. At step 408, the method 400 determines the red, green blue (RGB) values related to the extracted portion. At step 410, the method 400 performs automatic white balance based on the determined RGB values.

FIG. 5 is an embodiment of an apparatus 500 for performing automatic white balance utilizing a touch screen of a display, such as, an image capturing device, a camcorder, a camera, a hand-held device and the likes. The apparatus includes an area determination module 502, portion extraction module 504, RGB determination module 506, automatic white balance module 508, memory 510, processor 512, display module 514 and input/output module 516. The area determination module 502 is for determining an area on a touch screen display for performing automatic white balance. The portion extraction module 504 is for extracting portions of the frame relating to the determined frame. The RGB determination module 506 is for determines the red, green blue (RGB) values related to the extracted portion. The automatic white balance module 508 performs automatic white balance based on the determined RGB values.

The memory 510 may comprise non-transitory storage medium, random access memory, read only memory, removable disk memory, flash memory, and various combinations of these types of memory. The memory 510 is sometimes referred to main memory and may, in part, be used as cache memory or buffer memory. The memory 510 may store an operating system (OS), database software, various forms of application software. The processor may utilize the memory or assist any module in performing its task. The display module 514 may retrieve image or frame data from a display or be utilized by the input/output device 516 to display such an image. The input/output device 516 that is capable of outputting and/or inputting data, such as, a display, a touch screen, a printer, a key pad and the likes.

Therefore, the touch screen based white balance technology gives the end user great flexibility, capability, and creativity in achieving the desired color balance and tone of their digital images. It essentially takes advantage of the human visual system to assist white balance correction. This method can be easily incorporated into any display, for example, any image capturing device or hand-held, camera, camcorder and the likes. The results are instantly available and may be conveniently reconfigured. It can be used as a stand-alone method or complement the existing automatic white balance into a device.

Hence, this method can produce more reliable and accurate white balance that is robust to object colors, mixed lightings, and other typical automatic white balance algorithm challenges. It also allows for more creative control over the color tone of a captured image. In addition, such a method is convenient and flexible for user to perform real-time white balance and adjustment. It also produces better white balance accuracy than using the common pre-set AWB illumination mode.

While the foregoing is directed to embodiments of the present invention, other and further embodiments of the invention may be devised without departing from the basic scope thereof, and the scope thereof is determined by the claims that follow.

1. A method for performing automatic white balance utilizing a touch screen, comprising:
determining an area on a touch screen for performing automatic white balance;
extracting portion of a frame relating to the determined area;
determining red, green and blue values of the extracted portion of the frame; and
performing automatic white balance based on the determined red, green and blue values.

2. The method of claim 1, wherein a user selects the area on the touch screen for performing automatic white balance.

3. The method of claim 1, wherein the touch screen is coupled to at least one of an image capturing device, display device, a camcorder, a camera, a hand-held device, or a television.

4. An apparatus for performing automatic white balance utilizing a touch screen, comprising:
means for determining an area on a touch screen for performing automatic white balance;
means for extracting portion of a frame relating to the determined area;
means for determining red, green and blue values of the extracted portion of the frame; and
means for performing automatic white balance based on the determined red, green and blue values.

5. The apparatus of claim 4, wherein a user selects the area on the touch screen for performing automatic white balance.

6. The apparatus of claim 4, wherein the touch screen is coupled to at least one of an image capturing device, display device, a camcorder, a camera, a hand-held device, or a television.

7. A non-transitory computer readable medium comprising software that, when executed by a processor, causes the processor to perform a method for performing automatic white balance utilizing a touch screen, comprising:
determining an area on a touch screen for performing automatic white balance;
extracting portion of a frame relating to the determined area;
determining red, green and blue values of the extracted portion of the frame; and
performing automatic white balance based on the determined red, green and blue values.

8. The non-transitory computer readable medium of claim 7, wherein a user selects the area on the touch screen for performing automatic white balance.

9. The non-transitory computer readable medium of claim 7, wherein the touch screen is coupled to at least one of an image capturing device, display device, a camcorder, a camera, a hand-held device, or a television.
